(19) United States
(12) Patent Application Publication
(10) Pub. No.: US 2024/0021180 A1
(43) Pub. Date: Jan. 18, 2024

(54) ELECTRONIC MUSICAL INSTRUMENT, ELECTRONIC MUSICAL INSTRUMENT CONTROL METHOD, AND PROGRAM

(71) Applicant: CASIO COMPUTER CO., LTD., Shibuya-ku, Tokyo (JP)

(72) Inventor: Hiroshi IWASE, Hamura-shi, Tokyo (JP)

(73) Assignee: CASIO COMPUTER CO., LTD., Shibuya-ku, Tokyo (JP)

(21) Appl. No.: 18/044,922

(22) PCT Filed: Aug. 13, 2021
(86) PCT No.: PCT/JP2021/029833

§ 371 Date: Mar. 10, 2023

(30) Foreign Application Priority Data
Sep. 11, 2020 (JP) 2020-152926

(51) Int. Cl. G10H 1/053; G10L 13/033

(52) U.S. Cl. CPC G10H 1/053; G10L 13/0335; G10H 2250/455; G10H 2210/375

(57) ABSTRACT

An electronic musical instrument includes a pitch designation unit configured to output performance time pitch data designated at a time of a performance, a performance style output unit configured to output performance time performance style data indicating a performance style at the time of the performance, and a sound generation model unit configured, based on an acoustic model parameter inferred by inputting the performance time pitch data and the performance time performance style data to a trained acoustic model, to synthesize and output musical sound data corresponding to the performance time pitch data and the performance time performance style data, at the time of the performance.

### TECHNICAL FIELD

The present invention relates to an electronic musical instrument, an electronic musical instrument control method, and a program for outputting a voice sound by driving a trained acoustic model in response to an operation on an operation element such as a keyboard.

### BACKGROUND ART

In electronic musical instruments, in order to supplement expressive power of a singing voice sound and a live musical instrument, which are weak points of the expressive power of a pulse code modulation (PCM) method of the related art, a technology of training an acoustic model, in which a human vocalization mechanism and a sound generation mechanism of a musical instrument are modeled by digital signal processing, by machine learning based on a singing operation and a performance operation and inferring and outputting sound waveform data of a singing voice or musical sound by driving the trained acoustic model, based on an actual performance operation is devised and put into practical use (for example, Patent Literature 1).

### CITATION LIST

### Patent Literature

Patent Literature 1: Japanese Patent No. 6,610,714

### SUMMARY OF INVENTION

### Technical Problem

When generating a singing voice waveform or musical sound waveform by machine learning, for example, the generated waveform often changes depending on changes in performance tempo, phrase-singing way, and performance style. For example, a sound generation time length of consonant portions in vocal voices, a sound generation time length of blowing sounds in wind instruments, and a time length for noise components when starting playing strings of a bowed string instrument are long in slow performances with few notes, and therefore, results in highly expressive and lively sounds, and are short in performances with many notes and a fast tempo, and therefore, results in articulated sounds.

However, when a user gives a performance in real time on a keyboard, etc., there is no way to convey a performance speed between notes that changes in response to change in score division of each note or difference in performance phrase in a sound source device, so that the acoustic model cannot infer an appropriate sound waveform corresponding to the change in performance speed between notes. As a result, for example, for a slow performance, the expressive power lacks, or conversely, the rising of the sound waveform generated for a fast-tempo performance is slow, making it difficult to give a performance.

Therefore, an object of the present invention is to enable inference of an appropriate sound waveform matched to a change in performance speed between notes that changes in real time.

### Solution to Problem

An electronic musical instrument as an example of an aspect includes a pitch designation unit configured to output performance time pitch data designated at a time of a performance, a performance style output unit configured to output performance time performance style data indicating a performance style at the time of the performance, and a sound generation model unit configured, based on an acoustic model parameter inferred by inputting the performance time pitch data and the performance time performance style data to a trained acoustic model, to synthesize and output musical sound data corresponding to the performance time pitch data and the performance time performance style data, at the time of the performance.

An electronic musical instrument as another example of the aspect includes a lyric output unit configured to output performance time lyric data indicating lyrics at a time of a performance, a pitch designation unit configured to output performance time pitch data designated in tune with an output of lyrics at the time of the performance, a performance style output unit configured to output performance time performance style data indicating a performance style at the time of the performance, and a vocalization model unit configured, based on an acoustic model parameter inferred by inputting the performance time lyric data, the performance time pitch data and the performance time performance style data to a trained acoustic model, to synthesize and output singing voice sound data corresponding to the performance time lyric data, the performance time pitch data and the performance time performance style data, at the time of the performance.

### Advantageous Effects of Invention

According to the present invention, it is possible to enable inference of an appropriate voice sound waveform matched to a change in performance speed between notes that changes in real time.

### BRIEF DESCRIPTION OF DRAWINGS

FIG. 1 shows an appearance example of an embodiment of an electronic keyboard musical instrument.

FIG. 2 is a block diagram showing a hardware configuration example of an embodiment of a control system of the electronic keyboard musical instrument.

FIG. 3 is a block diagram showing a configuration example of a voice training section and a voice synthesis section.

FIG. 4A is an explanatory diagram showing an example of score division, which is a basis of a singing way.

FIG. 4B is an explanatory diagram showing an example of score division, which is a basis of the singing way.

FIG. 5A shows a change in waveform of singing voice sound caused by a difference in performance tempo.

FIG. 5B shows a change in waveform of singing voice sound caused by a difference in performance tempo.

FIG. 6 is a block diagram showing a configuration example of a lyric output unit, a pitch designation unit, and a performance style output unit.

FIG. 7 shows a data configuration example of the present embodiment.

FIG. 8 is a main flowchart showing an example of control processing for the electronic musical instrument in the present embodiment.

FIG. 9A is a flowchart showing a detailed example of initialization processing.

FIG. 9B is a flowchart showing a detailed example of tempo-changing processing.

FIG. 9C is a flowchart showing a detailed example of song-starting processing.

FIG. 10 is a flowchart showing a detailed example of switch processing.

FIG. 11 is a flowchart showing a detailed example of keyboard processing.

FIG. 12 is a flowchart showing a detailed example of automatic performance interrupt processing.

FIG. 13 is a flowchart showing a detailed example of song playback processing.

### DESCRIPTION OF EMBODIMENTS

Hereinafter, embodiments of the present invention will be described in detail with reference to the drawings.

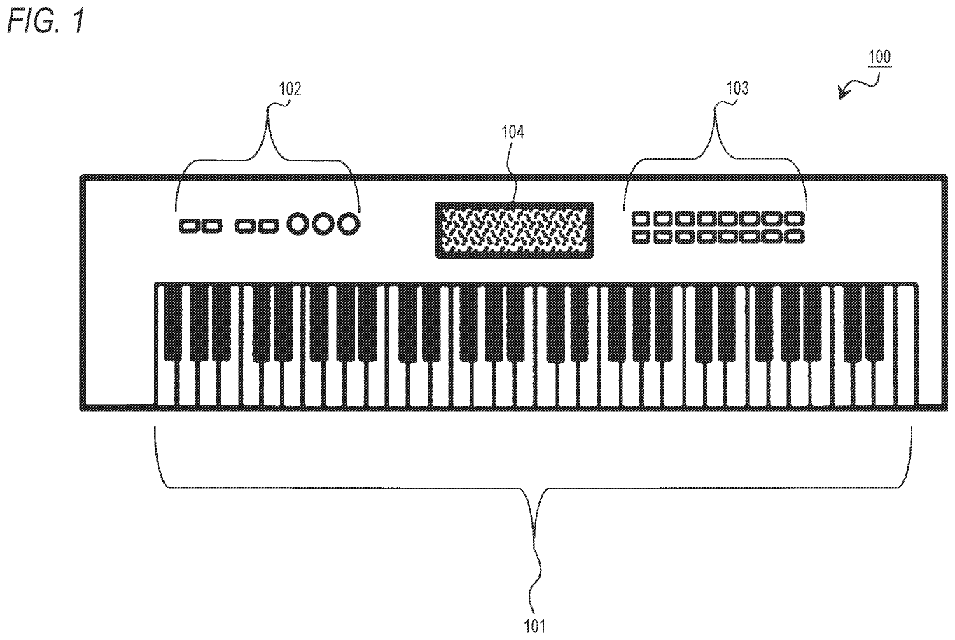

FIG. 1 shows an appearance example of an embodiment of an electronic keyboard musical instrument 100. The electronic keyboard instrument 100 includes a keyboard 101 consisting of a plurality of keys serving as operation elements, a first switch panel 102 configured to instruct a variety of settings such as a designation of a sound volume, a tempo setting of song playback (which will be described later), a setting of a performance tempo mode (which will be described later), an adjust setting of a performance tempo (which will be described later), a start of song playback (which will be described later) and accompaniment playback (which will be described later), a second switch panel 103 configured to select a song or an accompaniment and a tone color, a liquid crystal display (LCD) 104 configured to display a musical score and lyrics during song playback (which will be described later), and information relating to various setting. In addition, although not particularly shown, the electronic keyboard musical instrument 100 includes a speaker configured to emit musical sounds generated by performance and provided on a back surface part, a side surface part, a rear surface part or the like.

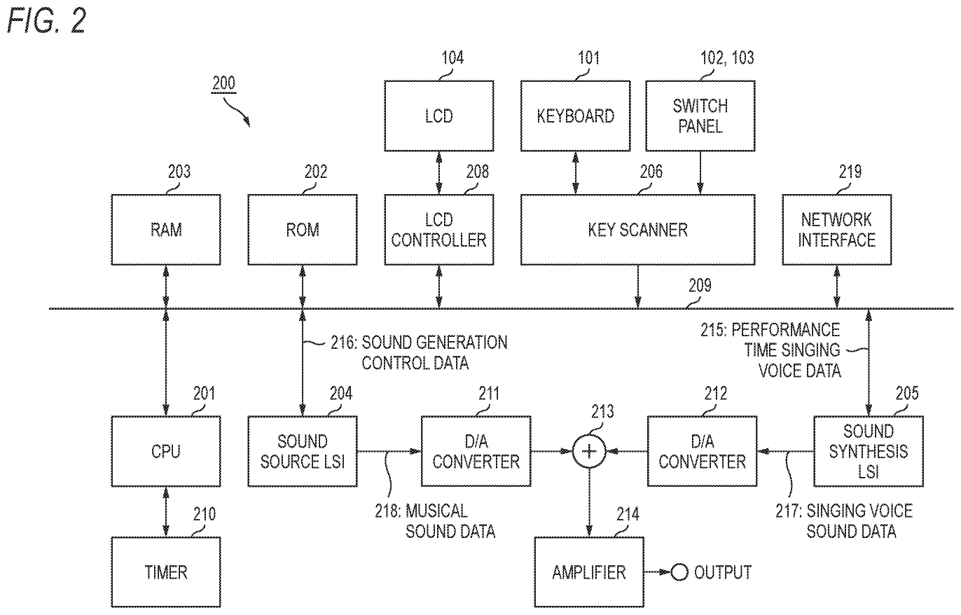

FIG. 2 shows a hardware configuration example of an embodiment of a control system 200 of the electronic keyboard musical instrument 100 shown in FIG. 1. In FIG. 2, in the control system 200, a CPU (central processing unit) 201, a ROM (read only memory) 202, a RAM (random access memory) 203, a sound source LSI (large-scale integration) 204, a voice synthesis LSI 205, a key scanner 206 to which the keyboard 101, the first switch panel 102 and the second switch panel 103 shown in FIG. 1 are connected, an LCD controller 208 to which the LCD 104 shown in FIG. 1 is connected and a network interface 219 configured to transmit and receive MIDI data and the like to and from an external network are each connected to a system bus 209. Further, a timer 210 for controlling a sequence of automatic performance is connected to the CPU 201. In addition, musical sound data 218 and singing voice sound data 217 that are each output from the sound source LSI 204 and the voice synthesis LSI 205 are converted into an analog musical sound output signal and an analog singing voice sound output signal by D/A converters 211 and 212, respectively. The analog musical sound output signal and the analog singing voice sound output signal are mixed in a mixer 213, and a mixed signal thereof is amplified in an amplifier 214, and is then output from a speaker or output terminal (which is not particularly shown).

The CPU 201 is configured to execute a control operation of the electronic keyboard musical instrument 100 shown in FIG. 1 by executing a control program loaded from the ROM 202 to the RAM 203 while using the RAM 203 as a work memory. In addition, the ROM 202 (non-temporary recording medium) is configured to store musical piece data including lyric data and accompaniment data, in addition to the control program and various types of fixed data.

The timer 210 that is used in the present embodiment is implemented on the CPU 201, and is configured to count progression of automatic performance in the electronic keyboard musical instrument 100, for example.

The sound source LSI 204 is configured to read out musical sound waveform data from a waveform ROM (which is not particularly shown), for example, and to output the same to the D/A converter 211, as musical sound data 218, in response to sound generation control data 216 from the CPU 201. The sound source LSI 204 is capable of 256-voice polyphony.

When the voice synthesis LSI 205 is given, as performance time singing voice data 215, text data of lyrics (performance time lyric data), data (performance time pitch data) designating each pitch corresponding to each lyric, and data relating to how to sing (performance time performance style data) from the CPU 201, the voice synthesis LSI synthesize singing voice sound data 217 corresponding to the data, and outputs the singing voice sound data to the D/A converter 212.

The key scanner 206 is configured to regularly scan pressed/released states of the keys on the keyboard 101 shown in FIG. 1, and switch operation states of the first switch panel 102 and the second switch panel 103, and to send an interrupt to the CPU 201 to transmit a state change.

The LCD controller 208 is an IC (integrated circuit) configured to control a display state of the LCD 104.

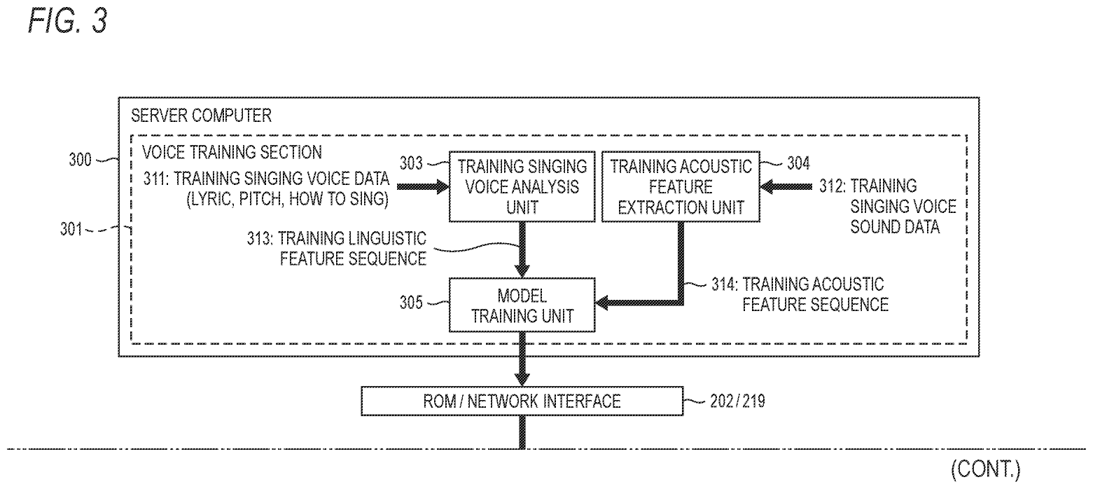

FIG. 3 is a block diagram showing a configuration example of a voice synthesis section and a voice training section in the present embodiment. Here, the voice synthesis section 302 is built into the electronic keyboard musical instrument 100, as one function that is executed by the voice synthesis LSI 205 in FIG. 2.

The voice synthesis section 302 synthesizes and outputs singing voice sound data 217 by inputting the performance time singing voice data 215 including lyrics, a pitch and information relating to how to sing instructed from the CPU 201 via the key scanner 206 in FIG. 2, based on the key pressing on the keyboard 101 in FIG. 1 by automatic playback (hereinafter, referred to as “song playback”) processing of lyrics, which will be described later. At this time, a processor of the voice synthesis section 302 executes vocalization processing of inputting, to a performance time singing voice analysis unit 307, the performance time singing voice data 215 including lyric information generated by the CPU 201 in response to an operation on any one of a plurality of keys (operation elements) on the keyboard 101, pitch information associated with any one key, and information relating to how to sing, inputting a performance time linguistic feature sequence 316 output from the performance time singing voice analysis unit to a trained acoustic model stored in an acoustic model unit 306, and outputting singing voice sound data 217 that infers a singing voice of a signer on the basis of spectral information 318 and sound source information 319 resultantly output by the acoustic model unit 306.

For example, as shown in FIG. 3, the voice training section 301 may be implemented as one function that is executed by a server computer 300 existing on an outside separately from the electronic keyboard musical instrument 100 in FIG. 1. Alternatively, although not shown in FIG. 3, the voice training section 301 may also be built into the electronic keyboard musical instrument 100 as one function that is executed by the voice synthesis LSI 205, if the voice synthesis LSI 205 in FIG. 2 has spare processing capacity.

The voice training section 301 and the voice synthesis section 302 shown in FIG. 2 are implemented based on, for example, the “statistical parametric speech synthesis based on deep learning” technology described in Non-Patent Literature 1 cited below.

(Non-Patent Literature 1) Kei Hashimoto and Shinji Takaki, “Statistical parametric speech synthesis based on deep learning”, Journal of the Acoustical Society of Japan, vol. 73, no. 1 (2017), pp. 55-62

The voice training section 301 in FIG. 2, which is a function that is executed by the external server computer 300 shown in FIG. 3, for example, includes a training singing voice analysis unit 303, a training acoustic feature extraction unit 304 and a model training unit 305.

The voice training section 301 uses, for example, voice sounds that were recorded when a certain singer sang a plurality of songs in an appropriate genre, as training singing voice sound data 312. In addition, text data (training lyric data) of lyrics of each song, data (training pitch data) designating each pitch corresponding to each lyric, and data (training performance style data) indicating the singing way of the training singing voice sound data 312 are prepared as training singing voice data 311. As the training performance style data, time intervals at which the training pitch data is sequentially designated are sequentially measured, and each data indicating the sequentially measured time intervals is designated.

The training singing voice data 311 including training lyric data, training pitch data and training performance style data is input to the training singing voice analysis unit 303. The training singing voice analysis unit 303 analyzes the input data. As a result, the training singing voice analysis unit 303 estimates and outputs a training linguistic feature sequence 313, which is a discrete numerical sequence representing a phoneme, a pitch, and a singing way corresponding to the training singing voice data 311.

In response to the input of the training singing voice data 311, the training acoustic feature extraction unit 304 receives and analyzes the training singing voice sound data 312 that has been recorded via a microphone or the like when a certain singer sang lyrics corresponding to the training singing voice data 311. As a result, the training acoustic feature extraction unit 304 extracts a training acoustic feature sequence 314 representing a feature of a voice sound corresponding to the training singing voice sound data 312, and outputs the same, as teacher data.

The training linguistic feature sequence 313 is represented by a following symbol.

ι [expression 1]

The acoustic model is represented by a following symbol.

λ [expression 2]

The training acoustic feature sequence 314 is represented by a following symbol.

o [expression 3]

A probability that the training acoustic feature sequence 314 will be generated is represented by a following symbol.

P(o|ι,λ) [expression 4]

An acoustic model that maximizes the probability that the training acoustic feature sequence 314 will be generated is represented by a following symbol.

\hat{λ} [expression 5]

The model training unit 305 estimates an acoustic model, which maximizes a probability that the training acoustic feature sequence 314 will be generated, by machine learning, from the training linguistic feature sequence 314 and the acoustic model, according to a following equation (1). That is, a relationship between a linguistic feature sequence, which is a text, and an acoustic feature sequence, which is a voice sound, is expressed by a statistical model called an acoustic model.

$$\begin{matrix}[ expression 6 ] & \\ \hat{λ} = arg {max}_{λ} P ( o \vert l , λ ) & ( 1 )\end{matrix}$$

Here, a following symbol indicates a computation of calculating a value of the argument underneath the symbol, which gives the greatest value for the function to the right of the symbol.

arg max [expression 7]

The model training unit 305 outputs training result data 315 expressing an acoustic model that is calculated as a result of machine learning by the computation shown in the equation (1). The calculated acoustic model is represented by a following symbol.

\hat{λ} [expression 8]

As shown in FIG. 3, for example, the training result data 315 may be stored in the ROM 202 of the control system shown in FIG. 2 for the electronic keyboard musical instrument 100 at the time of factory shipment of the electronic keyboard musical instrument 100 in FIG. 1, and may be loaded from the ROM 202 in FIG. 2 into the acoustic model unit 306, which will be described later, in the voice synthesis LSI 205 at the time of power-on of the electronic keyboard musical instrument 100. Alternatively, for example, as shown in FIG. 3, the training result data 315 may also be downloaded to the acoustic model unit 306 (which will be described later) in the voice synthesis LSI 205 via a network interface 219 from a network such as the Internet and a USB (Universal Serial Bus) cable (not particularly shown) by a user operation on the second switch panel 103 of the electronic keyboard musical instrument 100. Alternatively, apart from the voice synthesis LSI 205, the trained acoustic model may be realized in a form of hardware by an FPGA (Field-Programmable Gate Array) or the like, which may be then used as the acoustic model unit.

The voice synthesis section 302 that is a function to be executed by the voice synthesis LSI 205 includes a performance time singing voice analysis unit 307, an acoustic model unit 306, and a vocalization model unit 308. The voice synthesis section 302 executes statistical voice synthesis processing of sequentially synthesizing and outputting the singing voice sound data 217, which corresponds to the performance time singing voice data 215 sequentially input at a time of a performance, by making predictions using the statistical model referred to as the acoustic model set in the acoustic model unit 306.

As a result of a performance of a user in tune with an automatic performance, the performance time singing voice data 215, which includes information about performance time lyric data (phonemes of lyrics corresponding to a lyric text), performance time pitch data and performance time performance style data (data about how to sing) designated from the CPU 201 in FIG. 2, is input to the performance time singing voice analysis unit 307, and the performance time singing voice analysis unit 307 analyzes the input data. As a result, the performance time singing voice analysis unit 307 analyzes and outputs the performance time linguistic feature sequence 316 expressing phonemes, parts of speech, words, pitches, and a singing way corresponding to the performance time singing voice data 215.

In response to an input of the performance time linguistic feature sequence 316, the acoustic model unit 306 estimates and outputs, a performance time acoustic feature sequence 317, which is an acoustic model parameter corresponding to the input performance time linguistic feature sequence. The performance time linguistic feature sequence 316 input from the performance time singing voice analysis unit 307 is represented by a following symbol.

ι [expression 9]

An acoustic model set as the training result data 315 by machine learning in the model training unit 305 is represented by a following symbol.

\hat{λ} [expression 10]

The performance time acoustic feature sequence 317 is represented by a following symbol.

o [expression 11]

A probability that the performance time acoustic feature sequence 317 will be generated is represented by a following symbol.

P(o|ι,\hat{λ}) [expression 12]

An estimation value of the performance time acoustic feature sequence 317, which is an acoustic model parameter that maximizes the probability that the performance time acoustic feature sequence 317 will be generated, is represented by a following symbol.

ô [expression 13]

The acoustic model unit 306 estimates an estimation value of the performance time acoustic feature sequence 317, which is an acoustic model parameter that maximizes the probability that the performance time acoustic feature sequence 317 will be generated, based on the performance time linguistic feature sequence 316 input from the performance time singing voice analysis unit 307 and the acoustic model set as the training result data 315 by machine learning in the model training unit 305, in accordance with a following equation (2).

$$\begin{matrix}[ expression 14 ] & \\ \hat{o} = arg {max}_{o} P ( o \vert l , \hat{λ} ) & ( 2 )\end{matrix}$$

In response to an input of the acoustic feature sequence 317, the vocalization model unit 308 synthesizes and outputs the singing voice sound data 217 corresponding to the performance time singing voice data 215 designated from the CPU 201. This singing voice sound data 217 is output from the D/A converter 212 in FIG. 2 via the mixer 213 and the amplifier 214, and is emitted from the speaker not particularly shown.

The acoustic feature represented by the training acoustic feature sequence 314 or the performance time acoustic feature sequence 317 includes spectral information modeling a human vocal tract and sound source information modeling human vocal cords. As the spectral information (parameter), for example, mel-cepstrum, line spectral pairs (LSP) or the like may be employed. As the sound source information, a power value and a fundamental frequency (FO) indicating a pitch frequency of human voice can be employed. The vocalization model unit 308 includes a sound source generation unit 309 and a synthesis filter unit 310. The sound source generation unit 309 is a unit that models human vocal cords, and, in response to a sequence of the sound source information 319 being sequentially input from the acoustic model unit 306, generates sound source signal data consisting of pulse sequence data (in the case of a voiced sound phoneme) that periodically repeats with the fundamental frequency (FO) and the power value included in the sound source information 319, white noise data (in the case of an unvoiced sound phoneme) having the power value included in the sound source information 319 or a mixed data thereof, for example. The synthesis filter unit 310 is a unit that models the human vocal tract, and forms a digital filter modeling the vocal tract, based on a sequence of the spectral information 318 sequentially input from the acoustic model unit 306, and generates and outputs the singing voice sound data 321, which is digital signal data, by using the sound source data input from the sound source generation unit 309, as an excitation source signal data.

The sampling frequency for the training singing voice sound data 312 and the singing voice sound data 217 is, for example, 16 KHz (kilohertz). When a mel-cepstrum parameter obtained by mel-cepstrum analysis processing, for example, is employed for the spectral parameter included in the training acoustic feature sequence 314 and the performance time acoustic feature sequence 317, a frame update period thereof is, for example, 6 msec (milliseconds). In addition, when mel-cepstrum analysis processing is performed, an analysis window length is 25 msec, a window function is Blackman window function, and an analysis order is a twenty-four order.

As specific processing of statistical voice synthesis processing that is performed by the voice training section 301 and the voice synthesis section 302 in FIG. 3, a method of using hidden Markov model (HMM) or a method of using deep neural network (DNN) may be employed for an acoustic model expressed by the training result data 315 set in the acoustic model unit 306. Since the specific embodiments thereof are disclosed in Patent Literature 1 described above, the detailed description thereof is omitted in the present application.

Through the statistical voice synthesis processing that is performed by the voice training section 301 and the voice synthesis section 302 shown in FIG. 3, the electronic keyboard musical instrument 100 is implemented which outputs the singing voice sound data 217 that a certain signer sings well by allowing the performance time singing voice data 215, which includes song-played lyrics and pitches designated by the user's key pressing, to be sequentially input to the acoustic model unit 306 equipped with a trained acoustic model that has learned a singing voice of the certain singer.

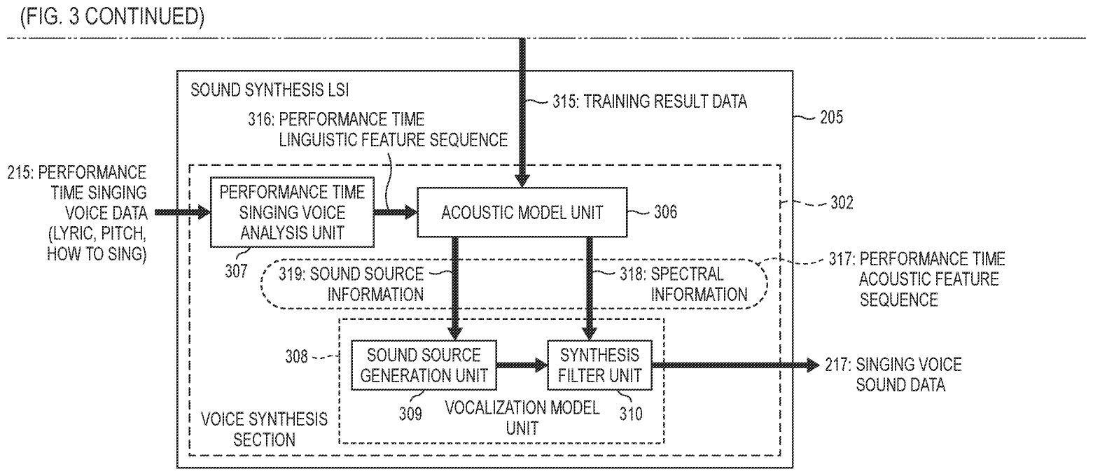

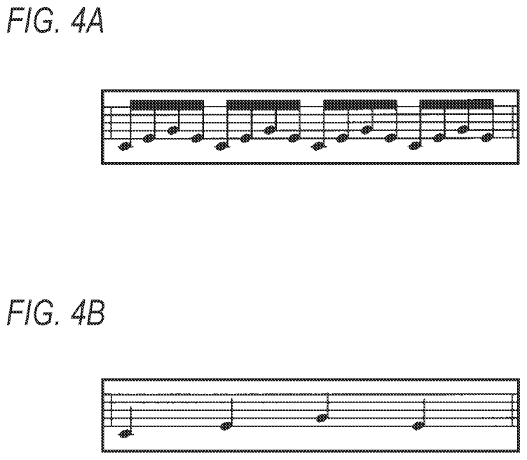

Here, in the singing voice, it is normal that there is a difference in singing way between a melody of a fast passage and a melody of a slow passage. FIGS. 4A and 4B are explanatory diagrams showing examples of score division, which is a basis of a singing way. FIG. 4A shows an example of a musical score of a lyric melody of a fast passage, and FIG. 4B shows an example of a musical score of a lyric melody of a slow passage. In these examples, the pitch change patterns are similar. However, FIG. 4A shows a score division of a sequence of sixteenth notes (a length of a note is ¼ of a quarter note), whereas FIG. 4B shows a score division of a sequence of quarter notes. Therefore, with respect to the speed of changing the pitch, the speed in the score division in FIG. 4A is four times the speed in the score division in FIG. 4B. In a musical piece with a fast passage, the consonant portions of the singing voice cannot be sung (performed) well unless shortened. To the contrary, in a musical piece with a slow passage, the singing (performance) with high expressive power can be played when the consonant portions of the singing voice are lengthened. As described above, even when the pitch change patterns are the same, the difference in length of each note of the singing melody (quarter note, eighth note, sixteenth note, etc.) causes a difference in singing (performance) speed. However, it is needless to say that even when the completely same musical score is sung (performed), a difference occurs in the performance speed when the tempo at the time of the performance changes. In the following description, a time interval (sound generation speed) between notes generated by the two factors described above is described as “performance tempo” so as to be distinguished from the tempo of a normal song.

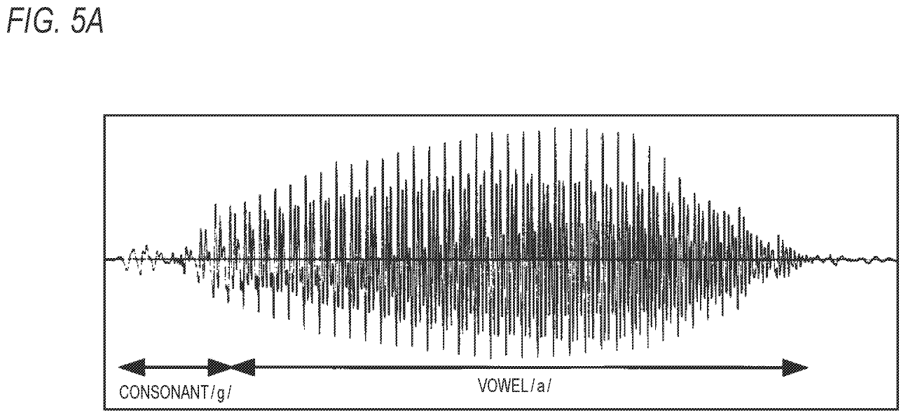

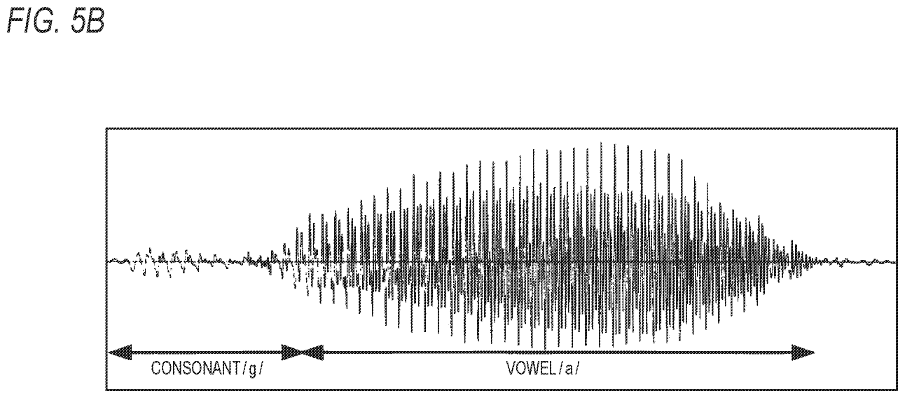

FIGS. 5A and 5B are diagrams showing changes in waveform of singing voice sound caused by a difference in performance tempo as shown in FIGS. 4A and 4B. The examples shown in FIGS. 5A and 5B show a waveform example of a singing voice sound when a voice sound of /ga/ is sound-generated. The voice sound of /ga/ is a combination of the consonant /g/ and the vowel /a/. A sound length (time length) of the consonant portion is usually several tens of milliseconds to about 200 milliseconds, in many cases. Here, FIG. 5A shows an example of a singing voice sound waveform when sung with a fast passage, and FIG. 5B shows an example of a singing voice sound waveform when sung with a slow passage. The difference between the waveforms in FIG. 5A and FIG. 5B is that the length of the consonant portion /g/ is different. It can be seen that when sung with a fast passage, as shown in FIG. 5A, the sound generation time length of the consonant portion is short, and conversely, when sung with a slow passage, as shown in FIG. 5B, the sound generation time length of the consonant portion is long. In singing at fast passages, priority is given to the sound generation start speed without clearly singing consonants. However, in singing at slow passages, consonants are often sound-generated long and clear, which increases the clarity of words.

In order to reflect the difference in performance tempo as described above to the change in singing voice sound data, in the statistical voice synthesis processing that is performed by the voice training section 301 and the voice synthesis section 302 shown in FIG. 3 of the present embodiment, the training singing voice data 311 that is input in the voice training section 301 is added with training lyric data indicating lyrics, training pitch data indicating pitches and training performance style data indicating a singing way, and information about performance tempo is included in the training performance style data. The training singing voice analysis unit 303 in the voice training section 301 analyzes the training singing voice data 311, thereby generating the training linguistic feature sequence 313. The model training unit 305 in the voice training section 301 performs machine learning by using the training linguistic feature sequence 313. As a result, the model training unit 305 can output the trained acoustic model including the information about the performance tempo, as the training result data 315, and store the same in the acoustic model unit 306 in the voice synthesis section 302 of the voice synthesis LSI 205. As the training performance style data, time intervals at which the training pitch data is sequentially designated are sequentially measured, and each performance tempo data indicating the sequentially measured time intervals is designated. In this way, the model training unit 305 of the present embodiment can perform training capable of deriving a trained acoustic model in which the difference in performance tempo due to the singing way is added.

On the other hand, in the voice synthesis section 302 including the acoustic model unit 306 in which the trained acoustic model is set as described above, performance time performance style data indicating a singing way is added to performance time lyric data indicating lyrics and performance time pitch data indicating pitch in the performance time singing voice data 215, and the information about the performance tempo can be included in the performance time performance style data. The performance time singing voice analysis unit 307 in the voice synthesis section 302 analyzes the performance time singing voice data 215 to generate the performance time linguistic feature sequence 316. Then, the acoustic model unit 306 in the voice synthesis section 302 outputs the corresponding spectral information 318 and sound source information 319 by inputting the performance time linguistic feature sequence 316 to the trained acoustic model, and supplies the spectral information and the sound source information to the synthesis filter unit 310 and the sound source generation unit 309 in the vocalization model unit 308, respectively. As a result, the vocalization model unit 308 can output the singing voice sound data 217 in which changes in the length of consonants or the like as shown in FIGS. 5A and 5B due to difference in performance tempo resulting from the singing way have been reflected. That is, it is possible to infer the appropriate singing voice sound data 217 matched to the change in performance speed between notes that changes in real time.

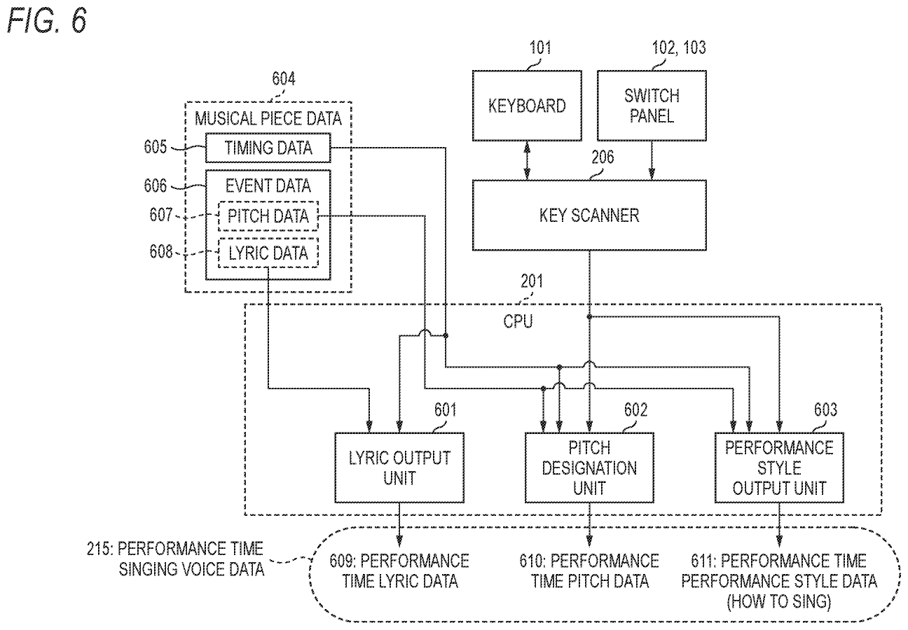

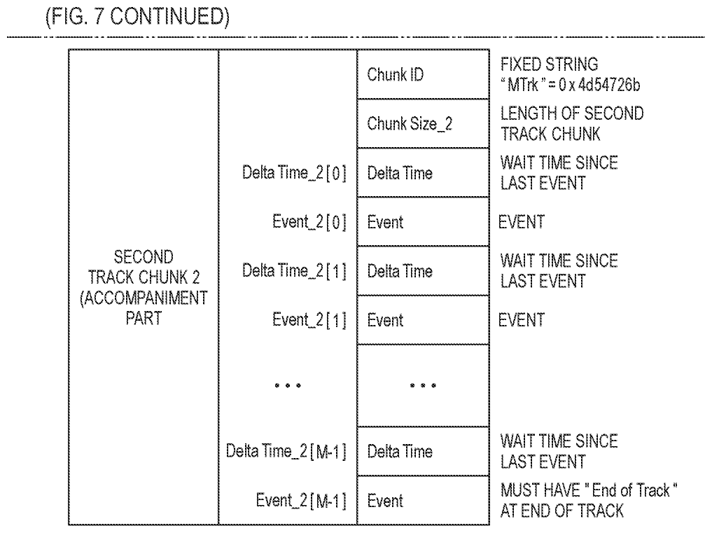

FIG. 6 is a block diagram showing a configuration example of a lyric output unit, a pitch designation unit, and a performance style output unit, which are implemented as functions of control processing shown in flowcharts in FIGS. 8 to 11 (which will be described later) by the CPU 201 shown in FIG. 2 so as to generate the performance time singing voice data 215 described above.

The lyric output unit 601 outputs each performance time lyric data 609 indicating lyrics at the time of a performance, with including the same in each performance time singing voice data 215 that is output to the voice synthesis LSI 205 in FIG. 2. Specifically, the lyric output unit 601 sequentially reads out each timing data 605 in musical piece data 604 for song playback loaded in advance from the ROM 202 to the RAM 203 by the CPU 201, sequentially reads out each lyric data (lyric text) 608 in each event data 606 stored as the musical piece data 604 in a pair with each timing data 605, in accordance with a timing indicated by each timing data 605, and sets each as performance time lyric data 609.

The pitch designation unit 602 outputs each performance time pitch data 610 indicating each pitch designated in tune with an output of each lyric at the time of a performance, with including the same in each performance time singing voice data 215 that is output to the voice synthesis LSI 205 in FIG. 2. Specifically, the pitch designation unit 602 sequentially reads out each timing data 605 in the musical piece data 604 for song playback loaded into the RAM 203, and sets, when pitch information relating to a key pressed as a result of a user pressing any one key on the keyboard 101 in FIG. 1 is input via the key scanner 206 at the timing indicated by each timing data 605, the pitch information as the performance time pitch data 610. In addition, the pitch designation unit 602 sets, when a user does not press any key on the keyboard 101 in FIG. 1 at the timing indicated by each timing data 605, the pitch data 607 of the event data 606 stored as the musical piece data 604 in a pair with the timing data 605, as the performance time pitch data 610.

The performance style output unit 603 outputs performance time performance style data 611 indicating a singing way that is a performance style at the time of a performance, with including the same in each performance time singing voice data 215 that is output to the voice synthesis LSI 205 in FIG. 2.

Specifically, when a user sets a performance tempo mode to a free mode on the first switch panel 102 in FIG. 1, as will be described later, the performance style output unit 603 sequentially measures time intervals at which pitches are designated by the user's key pressing at the time of a performance, and sets each performance tempo data indicating the sequentially measured time intervals, as each performance time performance style data 611.

On the other hand, when the user does not set the performance tempo mode to the free mode on the first switch panel 102 in FIG. 1, as will be described later, the performance style output unit 603 sets, as each performance time performance style data 611, each performance tempo data corresponding to each time interval indicated by each timing data 605 sequentially read out from the musical piece data 604 for song playback loaded in the RAM 203.

In addition, when the user sets the performance tempo mode to a performance tempo adjustment mode for intentionally changing a performance tempo mode on the first switch panel 102 in FIG. 1, as will be described later, the performance style output unit 603 intentionally changes, based on a value of the performance tempo adjustment setting, a value of each performance tempo data sequentially obtained as described above, and sets each performance tempo data after the change as the performance time performance style data 611.

In this way, each function of the lyric output unit 601, the pitch designation unit 602, and the performance style output unit 603 that are executed by the CPU 201 in FIG. 2 can generate the performance time singing voice data 215, which includes the performance time lyric data 609, the performance time pitch data 610 and the performance time performance style data 611, at the timing at which the key pressing event has occurred by the user's key pressing or by the song playback, and can issue the same to the voice synthesis section 302 in the voice synthesis LSI 205 having the configuration in FIG. 2 or FIG. 3.

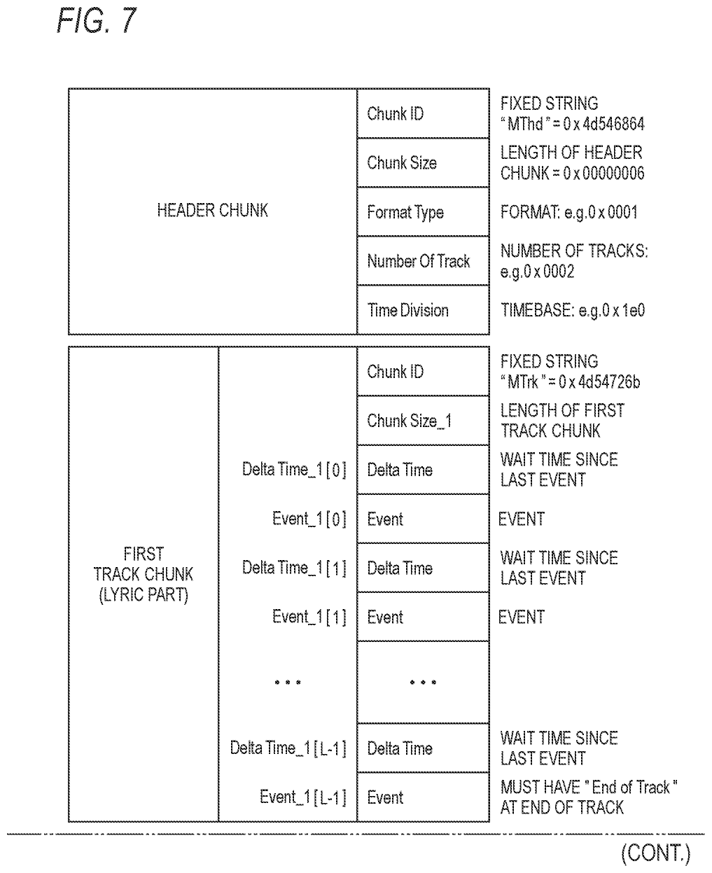

An operation of the embodiment of the electronic keyboard musical instrument 100 in FIGS. 1 and 2 using the statistical voice synthesis processing described in FIGS. 3 to 6 will be described in detail below. FIG. 7 is a diagram showing a detailed data configuration example of musical piece data loaded from the ROM 202 into the RAM 203 in FIG. 2, in the present embodiment. This data configuration example conforms to the standard MIDI file format, which is one of the file formats for MIDI (Musical Instrument Digital Interface). This musical piece data is configured by data blocks called chunks. Specifically, the musical piece data is configured by a head chunk at the beginning of a file, a first track chunk that comes after the header chunk and stores lyric data for a lyric part, and a second track chunk that stores performance data for an accompaniment part.

The header chunk consists of four values: ChunkID, ChunkSize, Format Type, NumberOfTrack, and TimeDivision. ChunkID is a 4-byte ASCII code “4D 54 68 64” (numbers are hexadecimal) corresponding to the four half-width characters “MThd”, which indicates that the chunk is a header chunk. ChunkSize is 4-byte data indicating a data length of FormatType, NumberOfTrack and TimeDivision parts of the header chunk, excluding ChunkID and ChunkSize. The data length is fixed to six bytes “00 00 00 06” (numbers are hexadecimal). FormatType is 2-byte data “00 01” (numbers are hexadecimal) meaning that the format type is format 1, in which multiple tracks are used, in the case of the present embodiment. NumberOfTrack is 2-byte data “00 02” (numbers are hexadecimal) indicating that two tracks corresponding to the lyric part and the accompaniment part are used, in the case of the present embodiment. TimeDivision is data indicating a timebase value, which indicates a resolution per quarter note, and in the case of the present embodiment, is 2-byte data “01 E0” (numbers are hexadecimal) indicating 480 in decimal notation.

The first track chunk indicates the lyric part, corresponds to the musical piece data 604 in FIG. 6, and is configured by ChunkID, ChunkSize, and a performance data pair (0≤i≤L−1) consisting of DeltaTime_1[i] corresponding to the timing data 605 in FIG. 6 and Event_1[i] corresponding to the event data 606 in FIG. 6. In addition, the second track chunk corresponds to the accompaniment part, and is configured by ChunkID, ChunkSize, and a performance data pair (0≤j≤M−1) consisting of DeltaTime_2[i], which is timing data of the accompaniment part, and Event_2[i], which is event data of the accompaniment part.

Each ChunkID in the first and second track chunks is a 4-byte ASCII code “4D 54 72 6B” (numbers are hexadecimal) corresponding to 4 half-width characters “MTrk”, which indicates that the chunk is a track chunk. Each ChunkSize in the first and second track chunks is 4-byte data indicating a data length of each track chunk, excluding ChunkID and ChunkSize.

DeltaTime_1[i], which is the timing data 605 in FIG. 6, is variable-length data of 1 to 4 bytes indicating a wait time (relative time) from an execution time of Event_1[i−1], which is the event data 605 in FIG. 6 immediately prior thereto. Similarly, DeltaTime_2[i], which is timing data of the accompaniment part, is variable-length data of 1 to 4 bytes indicating a wait time (relative time) from an execution time of Event_2[i−1], which is the event data of the accompaniment part immediately prior thereto.

Event_1[i], which is the event data 606 in FIG. 6, is a meta event having two pieces of information, i.e., vocalization text and pitch of a lyric in the first track chunk/lyric part of the present embodiment. Event 2[i], which is the event data of the accompaniment part, is a MIDI event designating note-on or note-off of the accompaniment sound, or a meta event designating a tempo of the accompaniment sound, in the second track chunk/accompaniment part.

In each performance data pair DeltaTime_[i] and Event_1[i] of the first track chunk/lyric part, Event_1[i], which is the event data 606, is executed after a wait of DeltaTime_1[i], which is the timing data 605, from the execution time of Event_1[i−1], which is the event data 606 immediately prior thereto. Thereby, the progression of song playback is realized. On the other hand, in each performance data pair DeltaTime_2[i] and Event 2[i] of the second track chunk/accompaniment part, Event_2[i], which is the event data, is executed after a wait of DeltaTime_2[i], which is the timing data, from the execution time of Event_2[i−1], which is the event data immediately prior thereto. Thereby, the progression of automatic accompaniment is realized.

FIG. 8 is a main flowchart showing an example of control processing for the electronic musical instrument in the present embodiment. For this control processing, for example, the CPU 201 in FIG. 2 executes a control processing program loaded from the ROM 202 into the RAM 203.

After first executing initialization processing (step S801), the CPU 201 repeatedly executes the series of processing from step S802 to step S808.

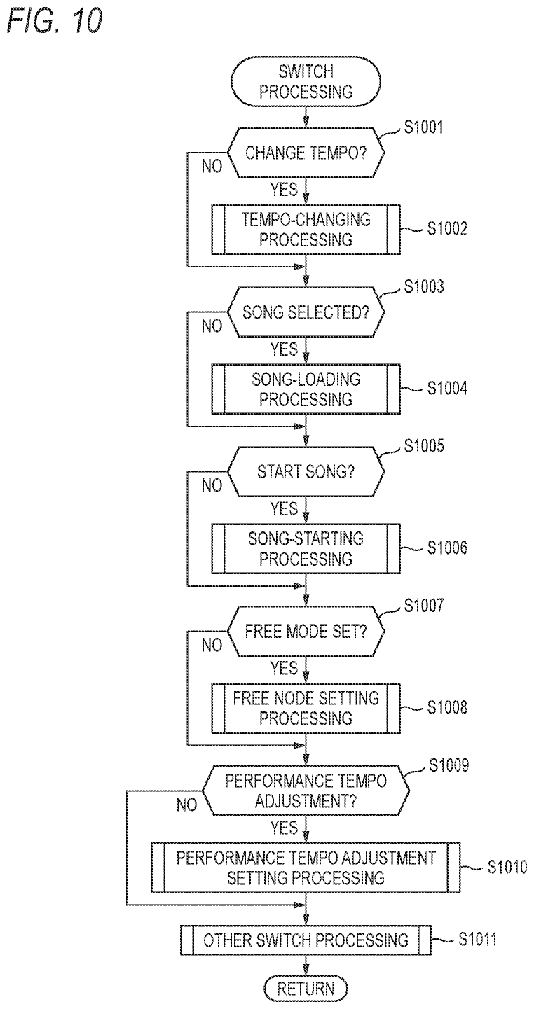

In this repeating processing, the CPU 201 first executes switch processing (step S802). Here, the CPU 201 executes processing corresponding to a switch operation on the first switch panel 102 or the second switch panel 103 in FIG. 1, based on an interrupt from the key scanner 206 in FIG. 2. The switch processing will be described in detail later with reference to a flowchart in FIG. 10.

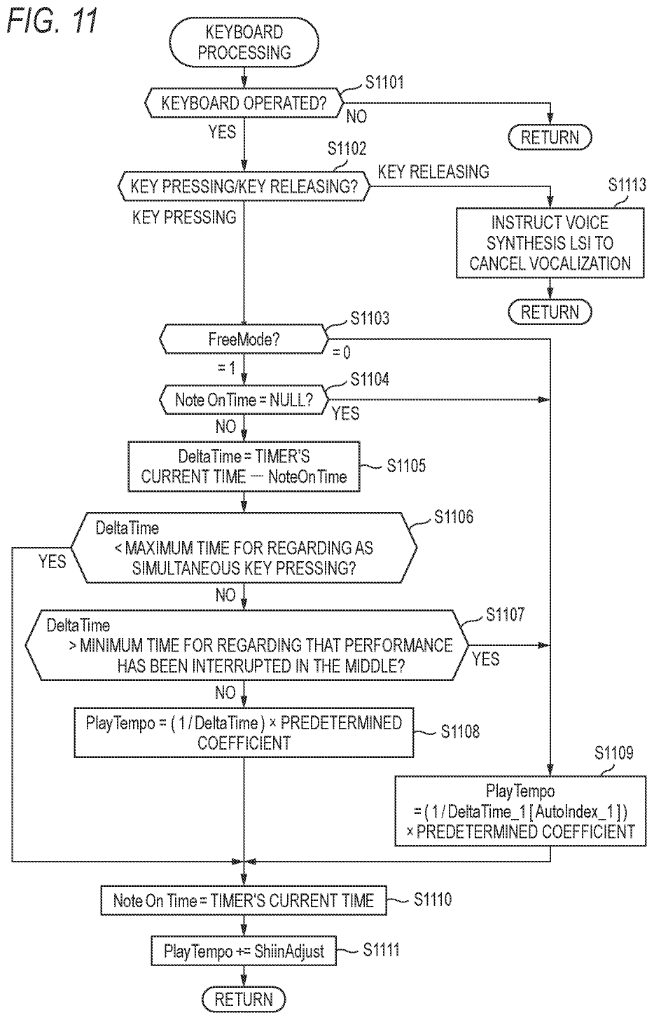

Next, the CPU 201 executes keyboard processing of determining whether any one key of the keyboard 101 in FIG. 1 has been operated, and proceeds accordingly, based on an interrupt from the key scanner 206 in FIG. 2 (step S803). In the keyboard processing, in response to a user operation of pressing or releasing any of the keys, the CPU 201 outputs musical sound control data 216 instructing the sound source LSI 204 in FIG. 2 to start generating sound or to stop generating sound. In addition, in the keyboard processing, the CPU 201 executes processing of calculating a time interval from an immediately previous key pressing to a current key pressing, as performance tempo data. The keyboard processing will be described in detail later with reference to a flowchart in FIG. 11.

Next, the CPU 201 processes data, which is to be displayed on the LCD 104 in FIG. 1, and executes display processing (step S804) of displaying the data on the LCD 104 via the LCD controller 208 in FIG. 2. Examples of the data that is to be displayed on the LCD 104 include lyrics corresponding to the singing voice sound data 217 being performed, a musical score for a melody and an accompaniment corresponding to the lyrics, and information relating to various setting.

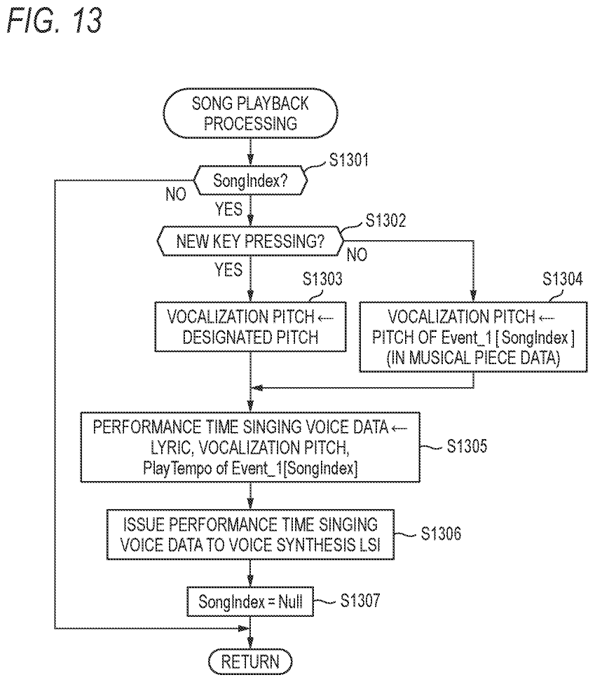

Next, the CPU 201 executes song playback processing (step S805). In the song playback processing, the CPU 201 generates and issues to the voice synthesis LSI 205 performance time singing voice data 215, which includes lyrics, vocalization pitch, and performance tempo for operating the voice synthesis LSI 205 based on song playback. The song playback processing will be described in detail later with reference to a flowchart in FIG. 13.

Subsequently, the CPU 201 executes sound source processing (step S806). In the sound source processing, the CPU 201 executes control processing such as processing for controlling the envelope of musical sounds being generated in the sound source LSI 204.

Subsequently, the CPU 201 executes voice synthesis processing (step S807). In the voice synthesis processing, the CPU 201 controls execution of voice synthesis by the voice synthesis LSI 205.

Finally, the CPU 201 determines whether the user has pressed a power-off switch (not particularly shown) to turn off the power (step S808). When the determination in step S808 is NO, the CPU 201 returns to the processing of step S802. When the determination in step S808 is YES, the CPU 201 ends the control processing shown in the flowchart of FIG. 8, and turns off the power supply of the electronic keyboard musical instrument 100.

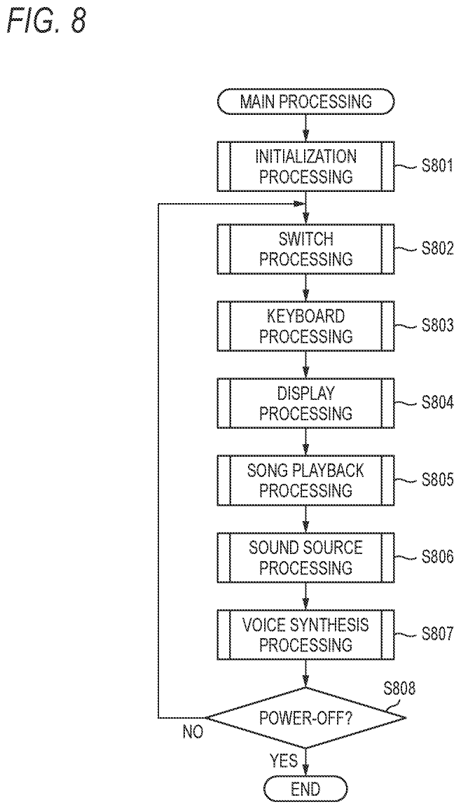

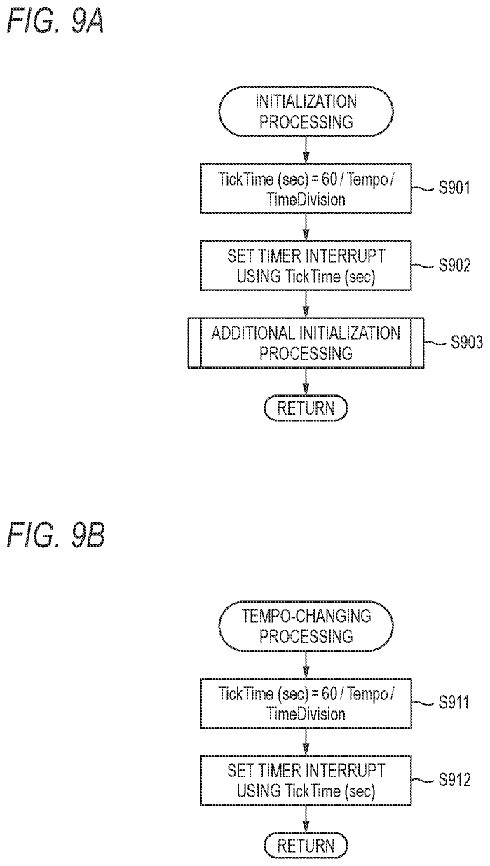

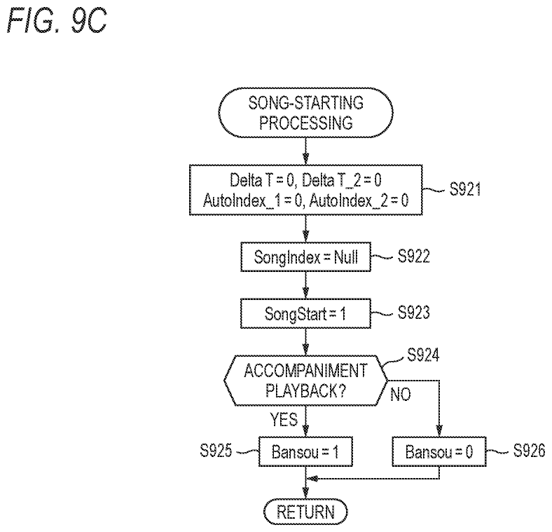

FIGS. 9A, 9B, and 9C are flowcharts each showing detailed examples of the initialization processing of step S801 in FIG. 8; tempo-changing processing of step S1002 in FIG. 10, and similarly, song-starting processing of step S1006 in FIG. 10, which will be described later, during the switch processing of step S802 in FIG. 8.

First, in FIG. 9A showing a detailed example of the initialization processing of step S801 in FIG. 8, the CPU 201 executes TickTime initialization processing. In the present embodiment, the progression of the lyrics and the automatic accompaniment progress in a unit of time called TickTime. The timebase value, designated as the TimeDivision value in the header chunk of the musical piece data in FIG. 7, indicates resolution per quarter note. If this value is, for example, 480, each quarter note has a time length of 480 TickTime. The DeltaTime_[i] values and the DeltaTime_2[i] values, indicating wait times in the track chunks of the musical piece data in FIG. 7, are also counted in units of TickTime. Here, the actual number of seconds corresponding to 1 TickTime differs depending on the tempo designated for the musical piece data. Taking a tempo value as Tempo (beats per minute) and the timebase value as TimeDivision, the number of seconds per unit of TickTime is calculated using the following equation (3).

[expression 15]

TickTime [sec]=60/Tempo/TimeDivision (3)

Therefore, in the initialization processing shown in the flowchart of FIG. 9A, the CPU 201 first calculates TickTime (sec) by arithmetic processing corresponding to the equation (10) (step S901). Note that, it is assumed that a prescribed value for the tempo value Tempo, for example, 60 (beats per second), is stored in the ROM 202 in FIG. 2 in an initial state. Alternatively, the tempo value at the time when previous processing ended may be stored in a non-volatile memory.

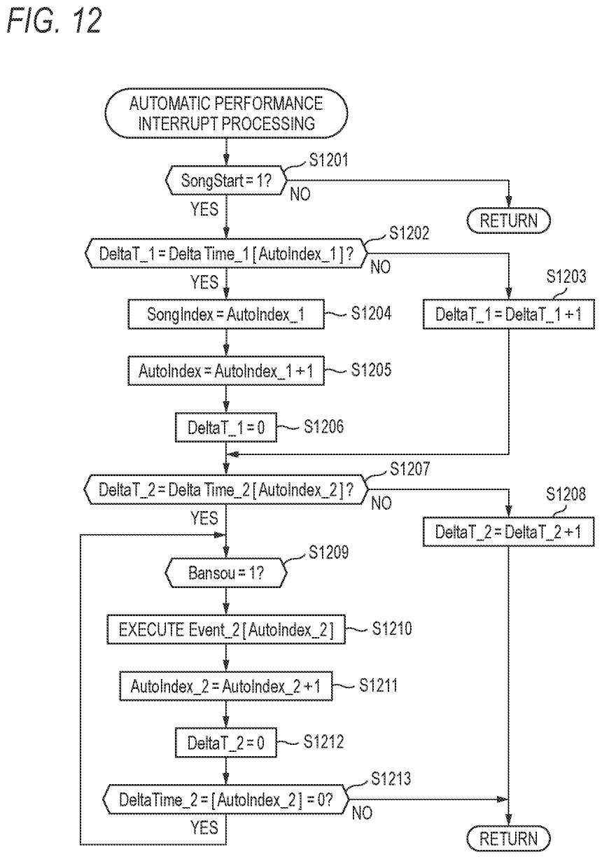

Next, the CPU 201 sets a timer interrupt for the timer 210 in FIG. 2 by using TickTime (sec) calculated at step S901 (step S902). As a result, an interrupt for song playback and automatic accompaniment (hereinafter, referred to as “automatic performance interrupt”) is generated to the CPU 201 by the timer 210 every time the TickTime (sec) has elapsed. Accordingly, in automatic performance interrupt processing (FIG. 12, which will be described later) that is executed by the CPU 201 based on the automatic performance interrupt, control processing for progressing song playback and automatic accompaniment is executed every 1 TickTime.

Subsequently, the CPU 201 executes additional initialization processing, such as that for initializing the RAM 203 in FIG. 2 (step S903). Thereafter, the CPU 201 ends the initialization processing of step S801 in FIG. 8 shown in the flowchart of FIG. 9A.

The flowcharts in FIGS. 9B and 9C will be described later. FIG. 10 is a flowchart showing a detailed example of the switch processing of step S802 in FIG. 8.

The CPU 201 first determines whether the tempo of lyric progression and automatic performance has been changed by a tempo-changing switch on the first switch panel 102 (step S1001). When the determination is YES, the CPU 201 executes tempo-changing processing (step S1002). This processing will be described in detail later with reference to FIG. 9B. When the determination in step S1001 is NO, the CPU 201 skips the processing of step S1002.

Next, the CPU 201 determines whether any one song has been selected with the second switch panel 103 in FIG. 1 (step S1003). When the determination is YES, the CPU 201 executes song-loading processing (step S1004). This processing is processing of loading musical piece data having the data structure described in FIG. 7 from the ROM 202 into the RAM 203 in FIG. 2. Note that, the song-loading processing may not be performed during a performance, and may be performed before the start of a performance. Subsequent data access to the first or second track chunk in the data structure shown in FIG. 7 is performed with respect to the musical piece data loaded into the RAM 203. When the determination in step S1003 is NO, the CPU 201 skips the processing of step S1004.

Subsequently, the CPU 201 determines whether a song-starting switch has been operated on the first switch panel 102 in FIG. 1 (step S1005). When the determination is YES, the CPU 201 executes song-starting processing (step S1006). This processing will be described in detail later with reference to FIG. 9C. When the determination in step S1005 is NO, the CPU 201 skips the processing of step S1006.

Subsequently, the CPU 201 determines whether a free mode switch has been operated on the first switch panel 102 in FIG. 1 (step S1007). When the determination is YES, the CPU 201 executes free mode setting processing of changing a value of a variable FreeMode on the RAM 203 (step S1008). The free mode switch can be operated in a toggle manner, for example, and an initial value of the variable FreeMode is set to a value of 1, for example, in step S903 in FIG. 9A. When the free mode switch is pressed in this state, the value of the variable FreeMode becomes 0, and when the free mode switch is pressed once more, the value of the variable FreeMode becomes 1. That is, whenever the free mode switch is pressed, the value of the variable FreeMode alternately switches between 0 and 1. When the value of the variable FreeMode is 1, a free mode is set, and when the value is 0, the free mode setting is canceled. When the determination in step S1007 is NO, the CPU 201 skips the processing of step S1008.

Subsequently, the CPU 201 determines whether a performance tempo adjustment switch has been operated on the first switch panel 102 in FIG. 1 (step S1009). When the determination is YES, the CPU 201 executes performance tempo adjustment setting processing of changing a value of a variable ShiinAdjust on the RAM 203 to a value designated by the numeric key on the first switch panel 102, following an operation on the performance tempo adjustment switch (step S1010). An initial value of the variable ShiinAdjust is set to a value 0 in step S903 in FIG. 9A, for example. When the determination in step S1009 is NO, the CPU 201 skips the processing of step S1010.

Finally, the CPU 201 determines whether other switches have been operated on the first switch panel 102 or the second switch panel 103 in FIG. 1, and executes processing corresponding to each switch operation (step S1011). Thereafter, the CPU 201 ends the switch processing of step S802 of FIG. 8 shown in the flowchart of FIG. 10.

FIG. 9B is a flowchart showing a detailed example of the tempo-changing processing of step S1002 in FIG. 10. As described above, a change in the tempo value also results in a change in the TickTime (sec). In the flowchart in FIG. 9B, the CPU 201 executes control processing relating to changing the TickTime (sec).

First, similarly to step S901 in FIG. 9A that is executed in the initialization processing of step S801 in FIG. 8, the CPU 201 calculates the TickTime (sec) by arithmetic processing corresponding to the equation (3) (step S911). Note that, it is assumed that the tempo value Tempo that has been changed using the tempo-changing switch on the first switch panel 102 in FIG. 1 is stored in the RAM 203 or the like.

Next, similarly to step S902 in FIG. 9A that is executed in the initialization processing of step S801 in FIG. 8, the CPU 201 sets a timer interrupt for the timer 210 in FIG. 2, using the TickTime (sec) calculated at step S911 (step S912). Subsequently, the CPU 201 ends the tempo-changing processing of step S1002 in FIG. 10 shown in the flowchart of FIG. 9B.

FIG. 9C is a flowchart showing a detailed example of the song-starting processing of step S1006 in FIG. 10.

First, with respect to the progression of automatic performance, the CPU 201 initializes the values of both a timing data variable DeltaT_1 (first track chunk) and a timing data variable DeltaT_2 (second track chunk) on the RAM 203 for counting, in units of TickTime, relative time since the last event to 0. Next, the CPU 201 initializes the respective values of a variable AutoIndex_1 on the RAM 203 for designating an i value (1≤i≤L−1) for a performance data pair DeltaTime_1[i] and Event_1[i] in the first track chunk of the musical piece data shown in FIG. 7, and a valuable AutoIndex_2 on the RAM 203 for designating an j value (1≤j≤M−1) for a performance data pair DeltaTime_2[j] and Event_2[j] in the second track chunk of the musical piece data shown in FIG. 7, to 0 (the above is step S921). Thus, in the example of FIG. 7, the performance data pair DeltaTime_1[0] and Event_1[0] at the beginning of the first track chunk and the performance data pair DeltaTime_2[0] and Event_2[0] at the beginning of the second track chunk are each referenced as an initial state.

Next, the CPU 201 initializes a value of a variable SongIndex on the RAM 203, which designates a current song position, to a null value (step S922). The null value is usually defined as 0 in many cases. However, since there is a case where the index number is 0, the null value is defined as −1 in the present embodiment.

The CPU 201 also initializes a value of a variable SongStart on the RAM 203, which indicates whether to advance (=1) or not to advance (=0) the lyrics and accompaniment, to 1 (advance) (step S923).

Then, the CPU 201 determines whether the user has made a setting to reproduce the accompaniment in tune with the playback of lyrics by using the first switch panel 102 in FIG. 1 (step S924).

When the determination in step S924 is YES, the CPU 201 sets a value of a variable Bansou on the RAM 203 to 1 (there is an accompaniment) (step S925). On the other hand, when the determination in step S924 is NO, the CPU 201 sets the value of the variable Bansou to 0 (there is no accompaniment) (step S926). After the processing of step S925 or S926, the CPU 201 ends the song-starting processing of step S1006 in FIG. 10 shown in the flowchart in FIG. 9C.

FIG. 11 is a flowchart showing a detailed example of the keyboard processing of step S803 in FIG. 8. First, the CPU 201 determines whether any one key on the keyboard 101 in FIG. 1 has been operated via the key scanner 206 in FIG. 2 (step S1101).

When the determination in step S1101 is NO, the CPU 201 ends the keyboard processing of step S803 in FIG. 8 shown in the flowchart in FIG. 11.

When the determination in step S1101 is YES, the CPU 201 determines whether a key pressing operation or a key releasing operation has been performed (step S1102).

When it is determined in the determination in step S1102 that the key releasing operation has been performed, the CPU 201 instructs the voice synthesis LSI 205 to cancel the vocalization of the singing voice sound data 217 corresponding to the key-released pitch (or key number) (step S1113). In response to this instruction, the voice synthesis section 302 in FIG. 3 in the voice synthesis LSI 205 stops vocalization of the corresponding singing voice sound data 217. Thereafter, the CPU 201 ends the keyboard processing of step S803 in FIG. 8 shown in the flowchart of FIG. 11.

When it is determined in the determination in step S1102 that the key pressing operation has been performed, the CPU 201 determines a value of the variable FreeMode on the RAM 203 (step S1103). The value of the variable FreeMode is set in step S1008 in FIG. 10 described above. When the value of the variable FreeMode is 1, the free mode is set, and when the value is 0, the free mode setting is canceled.

When it is determined in step 1103 that the value of the variable FreeMode is 0 and the free mode setting has been canceled, the CPU 201, as described above with respect to the performance style output unit 603 in FIG. 6, sets a value calculated by arithmetic processing shown in a following equation (4) using DeltaTime_1 [AutoIndex_1] described later, which is each timing data 605 sequentially read out from the musical piece data 604 for song playback loaded into the RAM 203, to a variable PlayTempo on the RAM 203 indicating a performance tempo corresponding to the performance time performance style data 611 in FIG. 6A (step S1109).

$$\begin{matrix}[ expression 16 ] & \\ Play Tempo = ( 1 / Delta Time\_ 1 [ Auto Index\_ 1 ] ) \times predetermined coefficient & ( 4 )\end{matrix}$$

In the equation (4), the predetermined coefficient is TimeDivision value of musical piece data×60 in the present embodiment. That is, if the TimeDivision value is 480, PlayTempo becomes 60 (corresponding to normal tempo 60) when DeltaTime_1[AutoIndex_1] is 480. When DeltaTime_1 [AutoIndex_1] is 240, PlayTempo becomes 120 (equivalent to normal tempo 120).

When the free mode setting has been canceled, the performance tempo is set in synchronization with the timing information relating to song playback.

When it is determined in step 1103 that the value of the variable FreeMode is 1, the CPU 201 further determines whether a value of a variable NoteOnTime on the RAM 203 is a null value (step S1104). At the start of song playback, for example, in step S903 in FIG. 9A, the value of the variable NoteOnTime has been initially set to a null value, and after the start of song playback, the current time of the timer 210 in FIG. 2 is sequentially set in step S1110, which will be described later.

At the time of the start of song playback and when the determination in step S1104 is YES, the performance tempo cannot be determined from the user's key pressing operation. Therefore, the CPU 201 sets a value calculated by the arithmetic processing shown in the equation (4) using DeltaTime_1 [AutoIndex_1], which is the timing data 605 on the RAM 203, to the variable PlayTempo on the RAM 203 (step S1109). In this way, at the start of song playback, the performance tempo is tentatively set in synchronization with the timing information relating to song playback.

After the start of song playback and when the determination in step S1104 is NO, the CPU 201 first sets a difference time, which is obtained by subtracting the value of the variable NoteOnTime on RAM 203 indicating the last key pressing time from the current time indicated by the timer 210 in FIG. 2, to a variable DeltaTime on the RAM 203 (step S1105).

Next, the CPU 201 determines whether the value of the variable DeltaTime, which indicates the difference time from the last key pressing time to the current key pressing time, is smaller than a predetermined maximum time for regarding as a simultaneous key pressing by chord performance (chord) (step S1106).

When the determination in step S1106 is YES and it is determined that the current key pressing is the simultaneous key pressing by chord performance (chord), the CPU 201 does not execute the processing for determining a performance tempo, and proceeds to step S1110, which will be described later.

When the determination in step S1106 is NO and it is determined that the current key pressing is not the simultaneous key pressing by chord performance (chord), the CPU 201 further determines whether the value of the variable DeltaTime, which indicates the difference time from the last key pressing to the current key pressing, is greater than a minimum time for regarding that the performance has been interrupted in the middle (step S1107).

When the determination in step S1107 is YES and it is determined that the key pressing is a key pressing (the beginning of the performance phrase) after the performance has been interrupted for a while, the performance tempo of the performance phrase cannot be determined. Therefore, the CPU 201 sets a value, which is calculated by the arithmetic processing shown in the equation (4) using DeltaTime_1 [AutoIndex_1] that is the timing data 605 on the RAM 203, to the variable PlayTempo on the RAM 203 (step S1109). In this way, in the case of the key pressing (the beginning of the performance phrase) after the performance has been interrupted for a while, the performance tempo is tentatively set in synchronization with the timing information relating to song playback.

When the determination in step S1107 is NO and it is determined that the current key pressing is neither the simultaneous key pressing by chord performance (chord) nor the key pressing at the beginning of the performance phrase, the CPU 201 sets a value obtained by multiplying a predetermined coefficient by a reciprocal of the variable DeltaTime indicating the difference time from the last key pressing to the current key pressing, as shown in a following equation (5), to the variable PlayTempo on the RAM 203 indicating the performance tempo corresponding to the performance time performance style data 611 in FIG. 6 (step S1108).

[expression 17]

PlayTempo=(1/DeltaTime)×predetermined coefficient (5)

As a result of the processing in step S1108, when the value of the variable DeltaTime indicating the difference time between the last key pressing and the current key pressing is small, the value of PlayTempo, which is the performance tempo, increases (the performance tempo becomes fast), the performance phrase is regarded as a fast passage, and in the voice synthesis section 302 in the voice synthesis LSI 205, a sound waveform of the singing voice sound data 217 in which the time length of the consonant portion is short as shown in FIG. 5A is inferred. On the other hand, when the value of the variable DeltaTime indicating the difference time is large, the value of the performance tempo becomes small (the performance tempo slows down), the performance phrase is regarded as a slow passage, and in the voice synthesis section 302, a sound waveform of the singing voice sound data 217 in which the time length of the consonant portion is long as shown in FIG. 5B is inferred.

After the processing of step S1108 described above, after the processing of step S1109 described above, or after the determination in step S1106 described above becomes YES, the CPU 201 sets the current time indicated by the timer 210 in FIG. 2 to the variable NoteOnTime on RAM 203 indicating the last key pressing time (step S1110).

Finally, the CPU 201 sets a value, which is obtained by adding the value of the variable ShiinAdjust (refer to step S1010 in FIG. 10) on the RAM 203 in which the performance tempo adjustment value intentionally set by the user is set to the value of the variable PlayTempo on the RAM 203 indicating the performance tempo determined in step S1108 or S1109, as a new value of the variable PlayTempo (step S1111). Thereafter, the CPU 201 ends the keyboard processing of step S803 in FIG. 8 shown in the flowchart of FIG. 11.

Through the processing of step S1111, the user can intentionally adjust the time length of the consonant portion in the singing voice sound data 217 synthesized in the voice synthesis section 302. In some cases, a user may want to adjust the singing way, depending on the song title or taste. For example, for some songs, when the user wants to give a performance with good sound generation by cutting the overall sound short, the user may want the voice sounds to be generated as if a sing were sung with speaking words quickly by shortening the consonants. Conversely, for some songs, when the user wants to give a performance comfortably as a whole, the user may want voice sounds to be generated, which can clearly transfer the breath of consonants as if a sing were sung slowly. Therefore, in the present embodiment, the user may change the value of the variable ShiinAdjust by, for example, operating the performance tempo adjustment switch on the first switch panel 102 in FIG. 1, and based on this, synthesize the singing voice sound data 217 reflecting the user's intention by adjusting the value of the variable PlayTempo. In addition to the switch operation, by operating a pedal using a variable resistor connected to the electronic keyboard instrument 100 with a foot, the value of ShiinAdjust can be finely controlled at an arbitrary timing of a piece of music.

The performance tempo value set to the variable PlayTempo by the keyboard processing described above is set as a part of the performance time singing voice data 215 in the song playback processing described later (refer to step S1305 in FIG. 13 described later) and issued to the voice synthesis LSI 205.

In the keyboard processing described above, in particular, the processing of steps S1103 to S1109 and step S1111 corresponds to the functions of the performance style output unit 603 in FIG. 6.

FIG. 12 is a flowchart showing a detailed example of the automatic performance interrupt processing that is executed based on the interrupts generated by the timer 210 in FIG. 2 every TickTime (sec) (refer to step S902 in FIG. 9A, or step S912 in FIG. 9B). The following processing is executed on the performance data pairs of the first and second track chunks in the musical piece data shown in FIG. 7.

First, the CPU 201 executes a series of processing (steps S1201 to S1206) corresponding to the first track chunk. First, the CPU 201 determines whether a value of SongStart is 1 (refer to step S1006 in FIG. 10 and step S923 in FIG. 9C), i.e., whether the progression of lyrics and accompaniment has been instructed (step S1201).

When it is determined that the progression of lyrics and accompaniment has not been instructed (the determination in step S1201 is NO), the CPU 201 ends the automatic performance interrupt processing shown in the flowchart in FIG. 12 without progression of lyrics and accompaniment.

When it is determined that the progression of lyrics and accompaniment has been instructed (the determination in step S1201 is YES), the CPU 201 determines whether the value of the valuable DeltaT_1 on the RAM 203, which indicates the relative time since the last event with respect to the first track chunk, matches DeltaTime_1[AutoIndex_1] on the RAM 203, which is the timing data 605 (FIG. 6) indicating the wait time of the performance data pair about to be executed indicated by the value of the variable AutoIndex_1 on the RAM 203 (step S1202).

When the determination in step S1202 is NO, the CPU 201 increments the value of the variable DeltaT_1, which indicates the relative time since the last event with respect to the first track chunk, by 1, and allows the time to advance by 1 TickTime unit corresponding to the current interrupt (step S1203). Thereafter, the CPU 201 proceeds to step S1207, which will be described later.

When the determination in step S1202 is YES, the CPU 201 stores the value of the variable AutoIndex_1, which indicates a position of the song event that should be performed next in the first track chunk, in the variable SongIndex on the RAM 203 (step S1204).

Also, the CPU 201 increments the value of the variable AutoIndex_1 for referencing the performance data pairs in the first track chunk by 1 (step S1205).

Further, the CPU 201 resets the value of the variable DeltaT_1, which indicates the relative time since the song event most recently referenced in the first track chunk, to 0 (step S1206). Thereafter, the CPU 201 proceeds to processing of step S1207.

Next, the CPU 201 executes a series of processing (steps S1207 to S1213) corresponding to the second track chunk. First, the CPU 201 determines whether the value of the valuable DeltaT_2 on the RAM 203, which indicates the relative time since the last event with respect to the second track chunk, matches DeltaTime_2[AutoIndex_2] on the RAM 203, which is the timing data of the performance data pair about to be executed indicated by the value of the variable AutoIndex_2 on the RAM 203 (step S1207).

When the determination in step S1207 is NO, the CPU 201 increments the value the variable DeltaT_2, which indicates the relative time since the last event with respect to the second track chunk, by 1, and allows the time to advance by 1 TickTime unit corresponding to the current interrupt (step S1208). Thereafter, the CPU 201 ends the automatic performance interrupt processing shown in the flowchart of FIG. 12.

When the determination in step S1207 is YES, the CPU 201 determines whether the value of the variable Bansou on the RAM 203 instructing accompaniment playback is 1 (there is an accompaniment) or not (there is no accompaniment) (step S1209) (refer to steps S924 to S926 in FIG. 9C).

When the determination in step S1209 is YES, the CPU 201 executes processing indicated by the event data Event_2 [AutoIndex_2] on the RAM 203 relating to the accompaniment of the second track chunk indicated by the value of the variable AutoIndex_2 (step S1210). When the processing indicated by the event data Event_2 [AutoIndex_2] executed here is, for example, a note-on event, the key number and velocity designated by the note-on event are used to issue an instruction to the sound source LSI 204 in FIG. 2 to generate musical sounds for an accompaniment. On the other hand, when the processing indicated by the event data Event_2 [AutoIndex_2] is, for example, a note-off event, the key number designated by the note-off event is used to issue an instruction to the sound source LSI 204 in FIG. 2 to cancel the musical sound for an accompaniment being generated.

On the other hand, when the determination in step S1209 is NO, the CPU 201 skips step S1210 and proceeds to processing of next step S1211 so as to progress in synchronization with the lyrics without executing the processing indicated by the event data Event_2[AutoIndex_2] relating to the current accompaniment, and executes only control processing that advances events.

After step S1210, or when the determination in step S1209 is NO, the CPU 201 increments the value of the variable AutoIndex_2 for referencing the performance data pairs for accompaniment data on the second track chunk by 1 (step S1211).

Next, the CPU 201 resets the value of the variable DeltaT 2, which indicates the relative time since the event most recently executed with respect to the second track chunk, to 0 (step S1212).

Then, the CPU 201 determines whether the value of the timing data DeltaTime_2[AutoIndex_2] on the RAM 203 of the performance data pair on the second track chunk to be executed next indicated by the value of the variable AutoIndex_2 is 0, i.e., whether this event is to be executed at the same time as the current event (step S1213).

When the determination in step S1213 is NO, the CPU 201 ends the current automatic performance interrupt processing shown in the flowchart in FIG. 12.

When the determination in step S1213 is YES, the CPU 201 returns to the processing of step S1209, and repeats the control processing relating to the event data Event_2[AutoIndex_2] on the RAM 203 of the performance data pair to be executed next on the second track chunk indicated by the value of the variable AutoIndex_2. The CPU 201 repeatedly executes the processing of steps S1209 to S1213 by the number of times to be simultaneously executed this time. The above processing sequence is executed when a plurality of note-on events are to generate sound at simultaneous timings, such as a chord.

FIG. 13 is a flowchart showing a detailed example of the song playback processing of step S805 in FIG. 8.

First, at step S1204 in the automatic performance interrupt processing in FIG. 12, the CPU 201 determines whether a new value other than the null value has been set for the variable SongIndex on the RAM 203 to enter a song playback state (step S1301). For the variable SongIndex, the null value is initially set in step S922 in FIG. 9C at the start of the song, a valid value of the variable AutoIndex_1 indicating the position of the song event to be executed next in the first track chunk is set in step S1204 that continues when the determination in step S1202 is YES in the automatic performance interrupt processing in FIG. 12 every time the singing voice playback timing arrives, and the null value is again set in step S1307 described later every time the song playback processing shown in the flowchart in FIG. 13 is further executed once. That is, whether the valid value other than the null value is set for the value of the variable SongIndex indicates whether the current timing is a song playback timing.

When the determination in step S1301 is YES, i.e., when the present time is a song playback timing, the CPU 201 determines whether a new user key pressing on the keyboard 101 in FIG. 1 has been detected by the keyboard processing of step S803 in FIG. 8 (step S1302).

When the determination in step S1302 is YES, the CPU 201 sets the pitch designated by the user key pressing, to a register not particularly shown or a variable on the RAM 203, as a vocalization pitch (step S1303).

On the other hand, when it is determined by the determination in step S1301 that the present time is the song playback timing and the determination in step S1302 is NO, i.e., it is determined that no new key pressing has been detected at the present time, the CPU 201 reads out the pitch data (corresponding to the pitch data 607 in the event data 606 in FIG. 6) from the song event data Event_1[SongIndex] on the first track chunk of the musical piece data on the RAM 203 indicated by the variable SongIndex on the RAM 203, and sets this pitch data to a register not particularly shown or a variable on the RAM 203 (step S1304).

Subsequently, the CPU 201 reads out the lyric string (corresponding to the lyric data 608 in the event data 606 in FIG. 6) from the song event Event_1[SongIndex] on the first track chunk of the musical piece data on the RAM 203 indicated by the variable SongIndex on the RAM 203. Then, the CPU 201 sets the performance time singing voice data 215, in which the read lyric string (corresponding to the performance time lyric data 609 in FIG. 6), the vocalization pitch acquired in step S1303 or S1304 (corresponding to the performance time pitch data 610 in FIG. 6) and the performance tempo obtained to the variable PlayTempo on the RAM 203 (corresponding to the performance time performance style data 611 in FIG. 6) in step S1111 in FIG. 10 corresponding to step S803 in FIG. 8 are set, to a register not particularly shown or a variable on the RAM 203 (step S1305).

Subsequently, the CPU 201 issues the performance time singing voice data 215 generated in step S1305 to the voice synthesis section 302 in FIG. 3 of the voice synthesis LSI 205 in FIG. 2 (step S1306). As described with reference to FIGS. 3 to 6, the voice synthesis LSI 205 infers, synthesizes, and outputs, from the lyrics designated by the performance time singing voice data 215, the singing voice sound data 217 that, in real time, corresponds to the pitch automatically designated as the pitch data 607 (refer to FIG. 6) by the user key pressing or song playback on the keyboard 101 designated by the performance time singing voice data 215 and sings a song appropriately at the performance tempo (singing way) designated by the performance time singing voice data 215.

Finally, the CPU 201 clears the value of the variable SongIndex so as to become a null value and makes subsequent timings non-song playback timings (step S1307). Thereafter, the CPU 201 ends the song playback processing of step S805 in FIG. 8 shown in the flowchart of FIG. 13.

In the above song playback processing, in particular, the processing of steps S1302 to S1304 corresponds to the function of the pitch designation unit 602 in FIG. 6. In particular, the processing of step S1305 corresponds to the function of the lyric output unit 601 in FIG. 6.

According to the embodiment described above, depending on the type of a musical piece to be performed and the performance phrase, the sound generation time length of the consonant portions in the vocal voice is long in performances with few notes of a slow passage and can result in highly expressive and lively sounds, and is short in performances with a fast tempo or many notes and can result in articulated sounds, for example. That is, it is possible to obtain a change in tone color that matches the performance phrase.

The embodiment described above is an embodiment of an electronic musical instrument configured to generate singing voice sound data, but as another embodiment, an embodiment of an electronic musical instrument configured to generate sounds of wind instruments or string instruments can also be implemented. In this case, the acoustic model unit corresponding to the acoustic model unit 306 in FIG. 3 stores a trained acoustic model that is subjected to machine learning by training pitch data designating pitches, teacher data corresponding to training acoustic data indicating acoustic of a certain sound source of a wind or string instrument corresponding to the pitches, and training performance style data indicating a performance style (for example, performance tempo) of the training acoustic data and outputs an acoustic model parameter corresponding to the input pitch data and performance style data. In addition, the pitch designation unit (corresponding to the pitch designation unit 602 in FIG. 6) outputs performance time pitch data indicating a pitch designated by the user's performance operation at the time of a performance. Further, the performance style output unit (corresponding to the performance style output unit 603 in FIG. 6) outputs performance time performance style data indicating the performance time performance style described above, for example, a performance tempo. The sound generation model unit (corresponding to the vocalization model unit 308 in FIG. 3) synthesizes and outputs musical sound data that infers a voice sound of a certain sound source, based on the acoustic model parameter that is output by inputting the above-described performance time pitch data and performance time performance style data to the trained acoustic model stored in the acoustic model unit, at the time of performance. In the embodiment of such an electronic musical instrument, for example, in a song with fast passages, pitch data such as the blowing sound of a wind instrument or as if the speed at which the bow strikes at the moment when strings of a string instrument are played with the bow slows down is inferred and synthesized, so that a performance with articulated sounds becomes possible. Conversely, in a song with low passages, pitch data such as the blowing sound of a wind instrument or as if the time at which the bow strikes at the moment when strings of a string instrument are struck with the bow is lengthened is inferred and synthesized, so that a performance with high . . . expressive power becomes possible.

In the embodiment described above, in the case in which the speed of the performance phrase cannot be estimated, such as the first key pressing or the first key pressing of the performance phrase, when singing or striking strongly, the rising portion of the consonant or sound is shortened, and when singing or striking weakly, the rising portion of the consonant or sound is lengthened. By using such a tendency, the intensity with which to play the keyboard (velocity value when pressing a key) may be used as a basis for calculation of a value of the performance tempo.

The voice synthesis method that can be adopted as the vocalization model unit 308 of FIG. 3 is not limited to the cepstrum voice synthesis method, and a variety of voice synthesis methods including an LSP voice synthesis method can be adopted.

In addition, as the voice synthesis method, in addition to the voice synthesis method based on the statistical voice synthesis processing using the HMM acoustic model and the statistical voice synthesis processing using the DNN acoustic model, any voice synthesis method may be employed as long as it is a technology using statistical voice synthesis processing based on machine learning, such as an acoustic model that combines HMM and DNN.

In the embodiment described above, the performance time lyric data 609 is given as the musical piece data 604 stored in advance. However, text data obtained by voice recognition performed on content being sung in real time by a user may be given as lyric information in real time.

Regarding the above embodiment, the following appendixes are further disclosed.

(Appendix 1)

An electronic musical instrument including:
a pitch designation unit configured to output performance time pitch data designated at a time of a performance;
a performance style output unit configured to output performance time performance style data indicating a performance style at the time of the performance; and
a sound generation model unit configured, based on an acoustic model parameter inferred by inputting the performance time pitch data and the performance time performance style data to a trained acoustic model, to synthesize and output musical sound data corresponding to the performance time pitch data and the performance time performance style data, at the time of the performance.

(Appendix 2)

An electronic musical instrument including:
a lyric output unit configured to output performance time lyric data indicating lyrics at a time of a performance;
a pitch designation unit configured to output performance time pitch data designated in tune with an output of lyrics at the time of the performance;
a performance style output unit configured to output performance time performance style data indicating a performance style at the time of the performance; and
a vocalization model unit configured, based on an acoustic model parameter inferred by inputting the performance time lyric data, the performance time pitch data and the performance time performance style data to a trained acoustic model, to synthesize and output singing voice sound data corresponding to the performance time lyric data, the performance time pitch data and the performance time performance style data, at the time of the performance.

(Appendix 3)

The electronic musical instrument according to Appendix 1 or 2, wherein the performance style output unit is configured to sequentially measure time intervals at which the pitch is designated at the time of the performance, and to sequentially output performance tempo data indicating the sequentially measured time intervals, as the performance time performance style data.

(Appendix 4)

The electronic musical instrument according to Appendix 3, wherein the performance style output unit includes a changing means for allowing a user to intentionally change the performance tempo data obtained sequentially.

(Appendix 5)

An electronic musical instrument control method including causing a processor of an electronic musical instrument to execute processing of:
outputting performance time pitch data designated at a time of a performance;
outputting performance time performance style data indicating a performance style at the time of the performance; and
based on an acoustic model parameter inferred by inputting the performance time pitch data and the performance time performance style data to a trained acoustic model, synthesizing and outputting musical sound data corresponding to the performance time pitch data and the performance time performance style data, at the time of the performance.

(Appendix 6)

An electronic musical instrument control method including causing a processor of an electronic musical instrument to execute processing of:
outputting performance time lyric data indicating lyrics at a time of a performance;
outputting performance time pitch data designated in tune with an output of lyrics at the time of the performance;
outputting performance time performance style data indicating a performance style at the time of the performance; and
based on an acoustic model parameter inferred by inputting the performance time lyric data, the performance time pitch data and the performance time performance style data to a trained acoustic model, synthesizing and outputting singing voice sound data corresponding to the performance time lyric data, the performance time pitch data and the performance time performance style data, at the time of the performance.

(Appendix 7)

A program for causing a processor of an electronic musical instrument to execute processing of:
outputting performance time pitch data designated at a time of a performance;
outputting performance time performance style data indicating a performance style at the time of the performance; and
based on an acoustic model parameter inferred by inputting the performance time pitch data and the performance time performance style data to a trained acoustic model, synthesizing and outputting musical sound data corresponding to the performance time pitch data and the performance time performance style data, at the time of the performance.

(Appendix 8)

A program for causing a processor of an electronic musical instrument to execute processing of:
outputting performance time lyric data indicating lyrics at a time of a performance;
outputting performance time pitch data designated in tune with an output of lyrics at the time of the performance;
outputting performance time performance style data indicating a performance style at the time of the performance; and
based on an acoustic model parameter inferred by inputting the performance time lyric data, the performance time pitch data and the performance time performance style data to a trained acoustic model, synthesizing and outputting singing voice sound data corresponding to the performance time lyric data, the performance time pitch data and the performance time performance style data, at the time of the performance.

The present application is based on Japanese Patent Application No. 2020-152926 filed on Sep. 11, 2020, the contents of which are incorporated herein by reference.

### REFERENCE SIGNS LIST

100: electronic keyboard musical instrument
101: keyboard
102: first switch panel
103: second switch panel
104: LCD
200: control system
201: CPU
202: ROM
203: RAM
204: sound source LSI
205: sound synthesis LSI
206: key scanner
208: LCD controller
209: system bus
210: timer
211, 211: D/A converter
213: mixer
214: amplifier
215: singing voice data
216: sound generation control data
217: singing voice sound data
218: musical sound data
219: network interface
300: server computer
301: voice training section
302: sound synthesis section
303 training singing voice analysis unit
304: training acoustic feature extraction unit
305: model training unit
306: acoustic model unit
307: performance time singing voice analysis unit
308: vocalization model unit
309: sound source generation unit
310: synthesis filter unit
311: training singing voice data
312: training singing voice sound data
313: training linguistic feature sequence
314: training acoustic feature sequence
315: training result data
316: performance time linguistic feature sequence
317: performance time acoustic feature sequence
318: spectral information
319: sound source information
601: lyric output unit
602: pitch designation unit
603: performance style output unit
604: musical piece data
605: timing data
606: event data
607: pitch data
608: lyric data
609: performance time lyric data
610: performance time pitch data
611: performance time performance style data

1. An electronic musical instrument including:
a pitch designation unit configured to output performance time pitch data designated at a time of a performance;
a performance style output unit configured to output performance time performance style data indicating a performance style at the time of the performance; and
a sound generation model unit configured, based on an acoustic model parameter inferred by inputting the performance time pitch data and the performance time performance style data to a trained acoustic model, to synthesize and output musical sound data corresponding to the performance time pitch data and the performance time performance style data, at the time of the performance.

2. An electronic musical instrument including:
a lyric output unit configured to output performance time lyric data indicating lyrics at a time of a performance;
a pitch designation unit configured to output performance time pitch data designated in tune with an output of lyrics at the time of the performance;
a performance style output unit configured to output performance time performance style data indicating a performance style at the time of the performance; and
a vocalization model unit configured, based on an acoustic model parameter inferred by inputting the performance time lyric data, the performance time pitch data and the performance time performance style data to a trained acoustic model, to synthesize and output singing voice sound data corresponding to the performance time lyric data, the performance time pitch data and the performance time performance style data, at the time of the performance.

3. The electronic musical instrument according to claim 1, wherein the performance style output unit is configured to sequentially measure time intervals at which the pitch is designated at the time of the performance, and to sequentially output performance tempo data indicating the sequentially measured time intervals, as the performance time performance style data.

4. The electronic musical instrument according to claim 3, wherein the performance style output unit includes a changing means for allowing a user to intentionally change the performance tempo data obtained sequentially.

5. An electronic musical instrument control method including causing a processor of an electronic musical instrument to execute processing comprising:
outputting performance time pitch data designated at a time of a performance; outputting performance time performance style data indicating a performance style at the time of the performance; and
based on an acoustic model parameter inferred by inputting the performance time pitch data and the performance time performance style data to a trained acoustic model, synthesizing and outputting musical sound data corresponding to the performance time pitch data and the performance time performance style data, at the time of the performance.

6. An electronic musical instrument control method including causing a processor of an electronic musical instrument to execute processing comprising:
outputting performance time lyric data indicating lyrics at a time of a performance;
outputting performance time pitch data designated in tune with an output of lyrics at the time of the performance;
outputting performance time performance style data indicating a performance style at the time of the performance; and
based on an acoustic model parameter inferred by inputting the performance time lyric data, the performance time pitch data and the performance time performance style data to a trained acoustic model, synthesizing and outputting singing voice sound data corresponding to the performance time lyric data, the performance time pitch data and the performance time performance style data, at the time of the performance.

7. A non-transitory computer-readable storage medium that stores a program for causing a processor of an electronic musical instrument to execute processing comprising:
outputting performance time pitch data designated at a time of a performance;
outputting performance time performance style data indicating a performance style at the time of the performance; and
based on an acoustic model parameter inferred by inputting the performance time pitch data and the performance time performance style data to a trained acoustic model, synthesizing and outputting musical sound data corresponding to the performance time pitch data and the performance time performance style data, at the time of the performance.

8. A non-transitory computer-readable storage medium that stores a program for causing a processor of an electronic musical instrument to execute processing comprising:
outputting performance time lyric data indicating lyrics at the time of a performance;
outputting performance time pitch data designated in tune with an output of lyrics at the time of the performance;
outputting performance time performance style data indicating a performance style at the time of the performance; and
based on an acoustic model parameter inferred by inputting the performance time lyric data, the performance time pitch data and the performance time performance style data to a trained acoustic model, synthesizing and outputting singing voice sound data corresponding to the performance time lyric data, the performance time pitch data and the performance time performance style data, at the time of the performance.
